(19) United States
(12) Patent Application Publication
(10) Pub. No.: US 2007/0118718 A1
(43) Pub. Date: May 24, 2007

(54) Method and device for providing address information for data transmission

(75) Inventors: Hugh Cautley, Leuven (BE); Adolf Proidl, Vessem (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/571,817

(22) PCT Filed: Sep. 14, 2004
(86) PCT No.: PCT/IB04/51751

§ 371 Date: Mar. 15, 2006

(30) Foreign Application Priority Data
Sep. 17, 2003 (EP) 03103415.0

(51) Int. Cl. G06F 12/00

(52) U.S. Cl. 711/202

(57) ABSTRACT

In an address information provision device (10) which is provided to provide address information (Aji) for transmission of information to a receiver (Rj) to whom at least two address information records (Aji) are assigned, a memory stage (12) for the storage of at least two address information records (Aji) assigned to the receiver (Rj) is provided, wherein each address information (Aji) defines a transmission method for transmission of the information, and a selection stage (15) is also provided, to which representation information (RI) representing the transmission information to be transmitted may be supplied and which, depending on the representation information (RI) supplied, is designed to select and provide one or more address information records (Aji).

The invention relates to an address information provision device for providing address information for data transmission to a receiver.

The invention also relates to an address information provision method for the provision of address information for data transmission to a receiver.

The invention also relates to a transmission information processing device with an address information provision device of the type referred to in the first paragraph and with a transmission device for data transmission.

The invention also relates to a computer program product which may be loaded directly into a memory of a computer, wherein the computer is able to execute the address information provision method in accordance with the preceding paragraph, when the computer program product is run on the computer.

The invention also relates to a computer with a central processing unit and an internal memory, and which is able to run a computer programs product in accordance with the preceding paragraph.

The invention also relates to a receiver device for receiving transmission information which may be transmitted with the aid of a transmission device, utilizing a message received beforehand.

Such an address information provision device of the type referred to in the first paragraph, and such an address information provision method of the type referred to in the second paragraph, and such a transmission information processing device of the type referred to in the third paragraph, and such a computer program product of the type referred to in the fourth paragraph, and such a computer of the type referred to in the fifth paragraph, and such a receiver device of the type referred to in the sixth paragraph are known in connection e-mail communication software brought onto the market by the Microsoft company and carrying the name “Outlook”.

The known address information provision device involves an electronic address book realized with the aid of the known computer program product and a computer on which the computer program product is run. On request, i.e. for example by entering a receiver name, address information in the form of an e-mail address which corresponds to the receiver name is provided. The e-mail address provided is used by an e-mail communication module to transmit an e-mail message forming transmission information in accordance with a predefined fixed transmission method, provided in the present case by an e-mail communication protocol.

The known address information provision device and the known address information provision method have the problem that, although an e-mail address of a receiver is provided automatically, transmission of the transmission information with the aid of the e-mail communication protocol takes an uneconomical length of time in practice, since the e-mail communication protocol is in practice unsuitable for transmission of the transmission information, which has a size of several megabytes or more, as is for example the case when an audio and/or video file is attached to an e-mail message.

It is an object of the invention to eliminate the problem referred to above, involving an address information provision device of the type referred to in the first paragraph, and an address information provision method of the type referred to in the second paragraph, and a transmission information processing device of the type referred to in the third paragraph, and a computer program product of the type referred to in the fourth paragraph, and a computer of the type referred to in the fifth paragraph, and a receiver device of the type referred to in the sixth paragraph, and to create an improved address information provision device and an improved address information provision method and an improved transmission information processing device and an improved computer program product and an improved computer and an improved receiver device.

To solve the problem referred to above, an address information provision device is provided with features according to the invention so that an address information provision device according to the invention may be characterized in the following manner, namely:

Address information provision device, said address information provision device being provided to supply address information for transmission of transmission information to a receiver to whom at least two address information records are assigned, and said address information provision device having storage means provided for the storage of the two or more address information records assigned to the receiver, wherein each address information defines a transmission method for transmission of the transmission information and said address information provision device has selection means to which representation information representing transmission information to be transmitted may be supplied and which, depending on the supplied representation information, are designed to select and provide one or more address information records.

To solve the problem referred to above, an address information provision method is provided with features according to the invention so that an address information provision method according to the invention may be characterized in the following manner, namely:

Address information provision method for the provision of address information for data transmission to a receiver, to whom at least two address information records are assigned, wherein at least two address information records assigned to the receiver, each defining a transmission method for data transmission, are stored, and wherein, depending on representation information representing the transmission information, one or more address information records is selected and provided.

To solve the problem referred to above, a transmission information processing device is provided with features according to the invention so that a transmission information processing device according to the invention may be characterized in the following manner, namely:

Transmission information processing device, said transmission information processing device being provided for the processing of transmission information, and said transmission information processing device having an address information provision device as claimed in any one of claims 1 to 5, and said transmission information processing device having a transmission device which is designed, using the address information provided by the address information provision device, to transmit the transmission information in accordance with the transmission method defined by the address information.

To solve the problem referred to above, in connection with a computer program product according to the invention, it is provided that the computer program product may be loaded directly into the memory of a computer and contains software code sections, wherein the computer may be used to execute the address information provision method according to the invention, when the computer program product is run on the computer.

To solve the problem referred to above, in connection with a computer according to the invention, it is provided that the computer has a central processing unit and an internal memory, and runs the computer program product according to the invention.

To solve the problem referred to above, a receiver device according to the invention is provided with features according to the invention so that a receiver device according to the invention may be characterized in the following manner, namely:

Receiver device, said receiver device being designed to receive transmission information which may be transmitted with the aid of a transmission device, utilizing a message received in advance, said message having request address information, wherein the request address information specifies from which transmission device the transmission information may be requested using that transmission method, which transmission method, with the aid of the address information provision device as claimed in any one of claims 1 to 5, has been defined by selecting the address information for transmission of the transmission information, and which receiver device has a request stage, said request stage being designed to request the transmission information from the transmission device addressed by the request address information in accordance with the transmission method.

This provides the benefit of automatic provision and use of address information which defines a transmission method suitable and to be preferred for data transmission, with this transmission method also actually being used to transmit the transmission information. This also provides the benefit that a user must specify only that he wishes to transmit transmission information to a receiver determined by himself, without being confronted with the situation where he must decide which technical transmission method is most suitable for data transmission. Accordingly a user is relieved of effort to the extent that, to transmit the transmission information to a receiver, he needs no expert knowledge with the aid of which he would evaluate the different address information belonging to a receiver to decide whether one address information record specifies that transmission method which is most suitable for data transmission. The situation may become even more complex in that the various address information records belonging to a user often require the management of different user interfaces to transmit the transmission information to the receiver and in certain circumstances may also specify various receiver devices of the receiver, which may in relationship with one another support completely different transmission methods.

The solutions according to the invention may also provide for the selection means to be provided in the form of representation information, whatever type of transmission information is involved—for example text information, still image information, sound information, audio/video information or real time audio/video information—and however many bytes the transmission information contains or whatever bit rate should be used in transmitting the transmission information. It has however proved to be especially advantageous if, in connection with the solutions according to the invention, the features as claimed in claims 2 and 7 respectively are provided. This gives the benefit that the address information most suitable for transmission is provided completely autonomously and using the methods of analysis which appear most suitable for different transmission information. This is of particular advantage when the address information provision device forms part of a server at which it should be possible to carry out the simplest possible central maintenance of the different methods of analysis, independently of the user terminal devices from which the transmission information is transmitted using the address information.

In connection with the solutions according to the invention it has also been found advantageous if the features as claimed in claims 3 and 8 respectively are also provided. The benefit thus obtained is that, even in the presence of an incomplete receiver name or in the presence of a term or a receiver indicator in general covering several receivers, suitable address information records for data transmission are provided.

In connection with the solutions according to the invention it has also been found advantageous if the features as claimed in claims 4 and 9 respectively are also provided. This gives the benefit of making possible a transaction, as for example in the case of a photo service agency, in which the transmission information represents a digital still image and several companies whose field of business extends to the printout of a still image in the form of a high-quality photo are possible receivers, wherein the address information corresponding to the receivers appears in the list depending on payments to an operator of the server—i.e. depending on the fee paid to that operator.

In connection with the solutions according to the invention it has also been found advantageous if the features as claimed in claims 5 and 10 respectively are also provided. The benefit thus obtained is that, although for a receiver there is no suitable transmission method for transmission of the complete transmission information, the transmission information may be transmitted in the form of transmission information elements, using a transmission method suitable for the transmission of the transmission information elements, where this is acceptable in respect of the transmission information to be transmitted, if the receiver needs to assemble the transmission information elements without error to form the complete transmission information, as for example is undoubtedly the case for an audio/video recording, but not absolutely essential for a plurality of still images.

In the case of a transmission information processing device according to the invention it has proved to be advantageous if the features as claimed in claim 11 are provided. The benefit thus obtained is that the benefits referred to above in connection with the address information provision device according to the invention are also available in the case of a transmission information processing device such as an entertainment electronics product, for example a hard disc video recorder, for which the provision of these measures makes possible the utilization of existing technical capacity—for example a network communication capacity—while avoiding a user interface which is complex to operate, as is usually required.

In the case of a transmission information processing device according to the invention it has proved to be advantageous if the features as claimed in claim 12 are provided. The benefit thus obtained is that if, at a particular time, a transmission method required to transmit certain transmission information is not available or can not be implemented at the receiver end, this particular transmission information may also be transmitted at a subsequent time in accordance with the transmission method defined by the address information.

In the case of a computer program product according to the invention it has also proved to be advantageous if the features as claimed in claim 14 are provided. The benefit thus obtained is that the computer program product may be distributed, sold or rented in the easiest possible manner.

In the case of a receiver device according to the invention it may be provided for example that the message is transmitted with the aid of peer-to-peer communication. It has however proved to be especially advantageous if the features as claimed in claim 17 are provided. The benefit thus obtained is that, even if the preferred transmission method is currently unavailable, this transmission method may be used at a subsequent time, and specifically in particular when the direct transmission of the transmission information from the transmission device to the receiver device is not possible without an active request of the transmission information from the receiver device, because the receiver device is protected from external data access by a so-called firewall.

In the case of a receiver device according to the invention it has also proved to be advantageous if the features as claimed in claim 18 are provided. The benefit thus obtained is that the request address information may be accommodated in the message in the most precise and unmistakable manner and may be evaluated by the receiver device without difficulty.

These and other aspects of the invention are apparent from the embodiment described below and are described with reference to this embodiment.

The invention is further described below with the aid of an embodiment shown in the drawings, to which however the invention is not limited.

In the drawings:

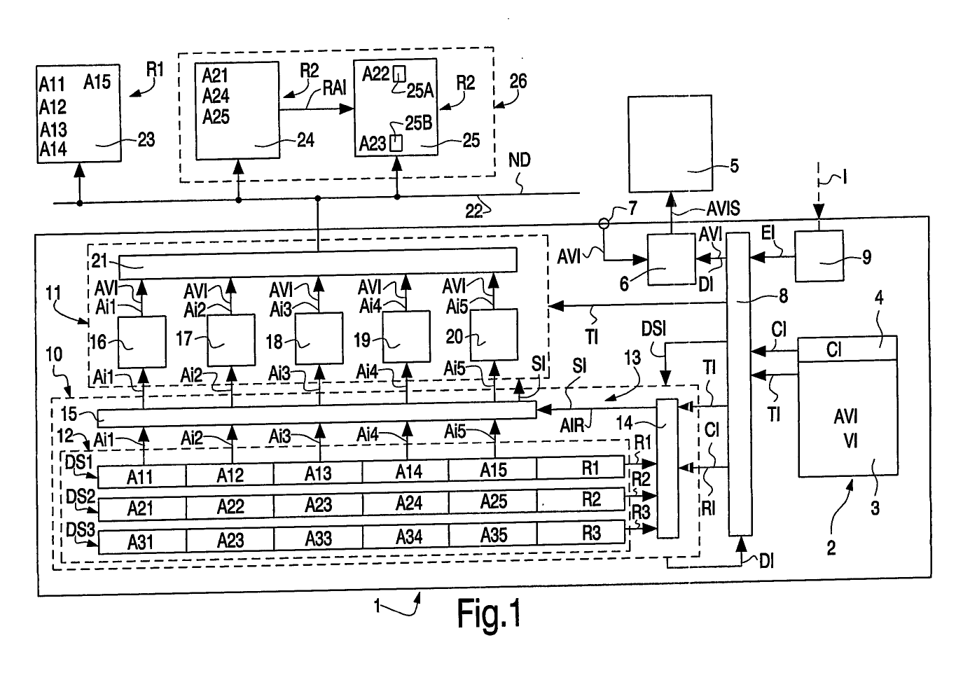

FIG. 1 shows schematically in the form of a block diagram a transmission information processing device with an address information provision device according to the invention, in accordance with a first embodiment of the invention.

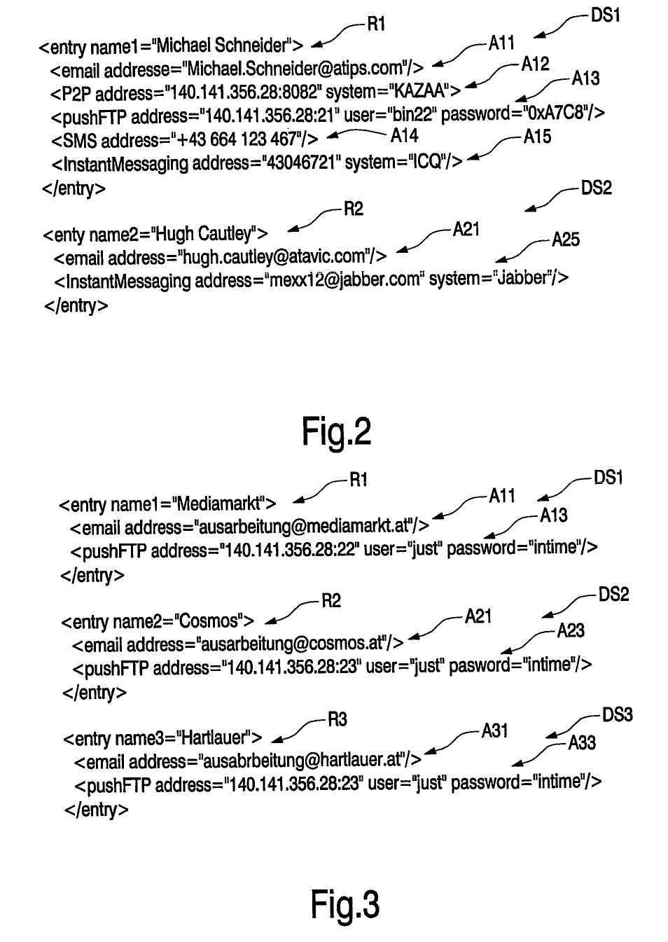

FIG. 2 shows, in plain text, address information contained in an electronic address book according to a first typical example of the invention.

FIG. 3 shows, in a similar manner to FIG. 2, address information according to a second typical example of the invention.

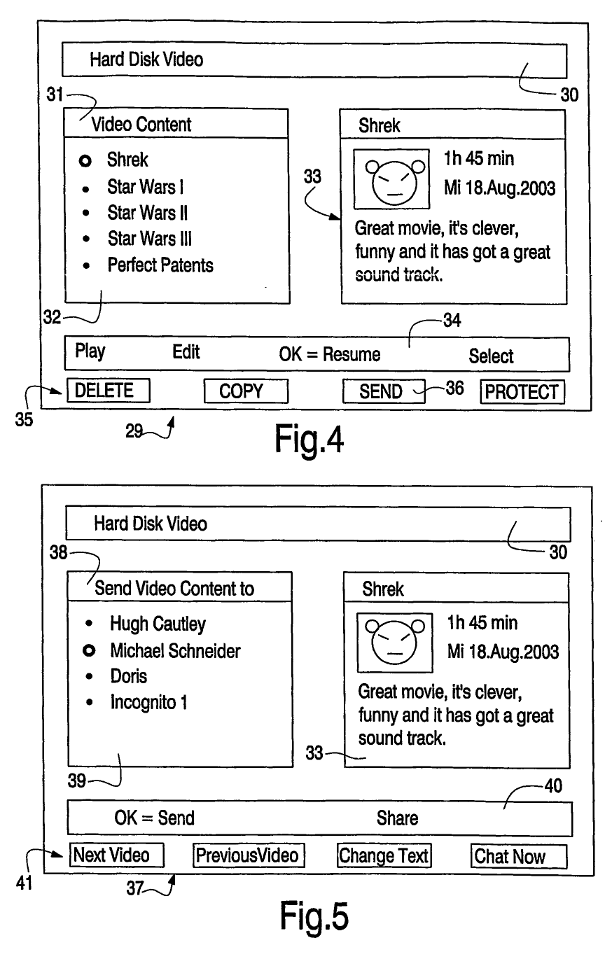

FIG. 4 shows schematically a first image content of a menu available on the transmission information processing device according to FIG. 1.

FIG. 5 shows schematically a second image content of the menu available on the transmission information processing device according to FIG. 1.

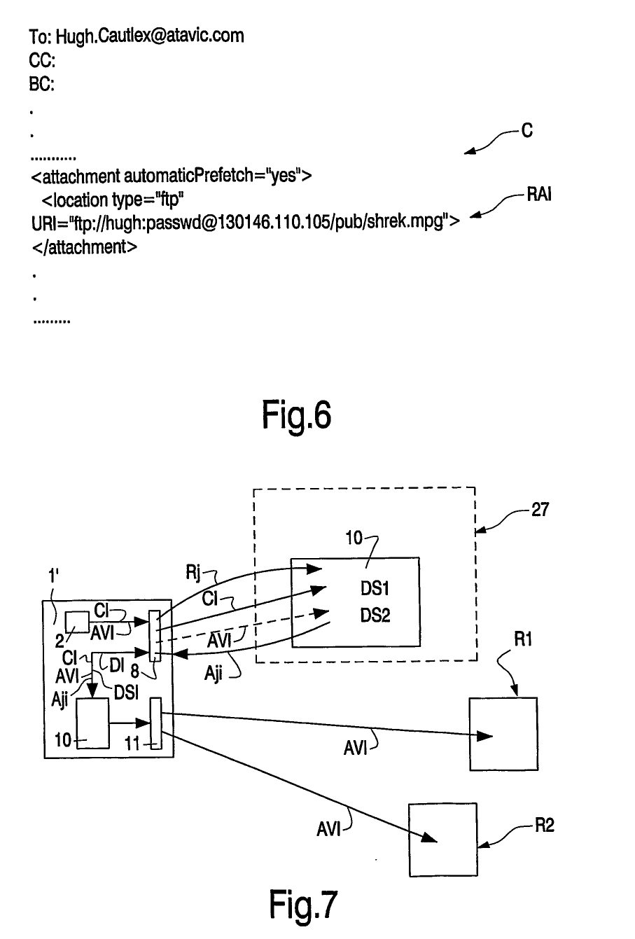

FIG. 6 shows an extract of content, relevant to the invention, of an e-mail message with request address information.

FIG. 7 shows very schematically in the form of a block diagram an address information server according to a second embodiment of the invention, which has an address information provision device according to the invention.

FIG. 1 shows a transmission information processing device which, in the present case, is in the form of a hard disc video recorder, subsequently described in short as the HD recorder 1. The HD recorder 1 has audio/video information storage means which are realized by a hard disc 2. The HD recorder 1 is designed for the processing of transmission information TI, formed in the present case by audio/video information AVI representing a video film recorded with the aid of the hard disk 2. The hard disk 2 has an audio/video information storage area 3 which is provided for the storage of the audio/video information AVI. The hard disk 2 also has a contents list storage area 4, in which is stored content information CI corresponding to the audio/video information AVI and describing the video film. The content information CI contains the name of the film, the recording date and time, the duration of the film, the volume of data in the film, and a brief textual description of the film. It should be mentioned at this point that the content information CI may also be provided in the form of so-called metadata. It may also be mentioned that the content information CI need not be stored in a separate contents list storage area 4, but may also be stored together with the audio/video information AVI in the audio/video information storage area 3.

The HD recorder 1 is also connected to an audio/video information playback device, realized in the present case by a TV set 5. The TV set 5 is designed to receive and process audio/video information signals AVIS, said audio/video information signals AVIS representing the video film stored with the aid of the hard disk 2, when this is played back, or a menu of the HD recorder 1 which may be generated with the aid of the HD recorder 1, and may be visualized with the aid of the TV set 5. For the purpose of generating and supplying the audio/video information signals AVIS, the HD recorder 1 has audio/video information processing means 6, to which the audio/video information AVI stored on the hard disk 2 may be supplied and which are designed to generate the audio/video information signals AVIS on the basis of the audio/video information AVI. The HD recorder 1 also has an audio/video information input connection 7, with the aid of which external audio/video information AVI may be fed to the HD recorder 1, from an external audio/video information source not shown in FIG. 1, for the purpose of internal processing, for example provision of the audio/video information signals AVIS or recording with the aid of the hard disk 2.

The HD recorder 1 also has information processing control means 8, which are designed on the one hand to control the processing of the external audio/video information AVI received over the audio/video information input connection 7 or the internal audio/video information AVI stored with the aid of the hard disk 2, and on the other hand to provide the menu of the HD recorder 1 via the TV set 5.

The HD recorder 1 also has input means 9 which are designed to cooperate with the information processing control means 8 and with the aid of which, an electronic representation EI of input information I which may be fed by a user to the HD recorder 1 may be supplied to the information processing control means 8. The input information I may be supplied to the HD recorder 1 through manual actuation of the input means 9 or by the use of a remote control. With the aid of the input means 9 the HD recorder 1 may be controlled for example in a video film selection mode, in which the content information CI stored in the hard disk 2 may be supplied to the TV set 5 via the audio/video information processing means 6, so that a user can select from a list of available stored video films a film which is of interest to him, with the aid of the input means 9.

The HD recorder 1 also has a network communication facility, with the aid of which one of the stored video films may be transmitted over a network 22 to a receiver Rj with j=1 . . . 3, wherein the index j indicates one of three possible receivers. To facilitate the most efficient possible network communication, the HD recorder 1 has an address information provision device 10 and a transmission device 11, to be described in detail below.

The address information provision device 10 is designed to provide address information Aji with i=1 . . . 5 for transmission of the transmission information TI to one of the receivers Rj, wherein the index i indicates one of five (5) addresses of a receiver Rj, to whom at least two address information records—in the present case five (5) address information records—are assigned. For this purpose the address information provision device 10 has storage means 12, provided for the storage of five address information records A1i for a first receiver R1, and five address information records A2i for a second receiver R2, and five address information records A3i for a third receiver R3. For the sake of clarity, FIG. 1 shows only three records DS1, DS2 and DS3 held in the storage means 12, but it should be noted that more than three (3) records may also be present. The records DS1 to DS 3 contain the three receiver names and the address information fields corresponding to the respective receiver Rj in which the five address information records A1i or A2i or A3i are stored.

Each of the address information records Aji defines a transmission method for data transmission. In the present case the address information records Aj1 define the transmission method of e-mail. The address information records Aj2 define the transmission method peer-to-peer, P2P in short. The address information records Aj3 define the transmission method file transfer protocol, FTP in short. The address information records Aj4 define the transmission method short-message-service, SMS in short. The address information records Aj5 define the transmission method of instant messaging via ICQ, IM in short.

The address information provision device 10 also has selection means 13 to which representation information RI may be fed from the information processing control means 8 and which are designed, depending on the representation information RI supplied, to select and provide at least one of the address information records Aji. The representation information RI represents the transmission information TI to the extent that it has information content which may be utilized in selecting the address information Aji.

The selection means 13 have an analysis stage 14 and a selection stage 15. The analysis stage 14 is designed to analyze the content information CI which may be fed to it by the information processing control means 8 in respect of the usable representation information RI contained in the content information CI, and to send analysis result information AIR characterizing the analyzed representation information RI to the selection stage 15. The analysis result information AIR gives the relevant address information Aj1 to Aj5 to be selected for a receiver Rj depending on the representation information RI. The selection stage 15 is designed to select the relevant address information Aj1 to Aj5 with the aid of the analysis result information AIR.

The selection means 13 are also designed, if the content information CI provided by the information processing control means 8 contains no representation information RI suitable for analysis, to receive the audio/video information AVI directly from the information processing control means 8 and to analyze it so that in such a case the representation information RI may be generated through direct analysis of the audio/video information AVI.

With the aid of the input means 9, the information processing control means 8 are also designed to access the address information provision device 10 and to read the names of the receivers Rj stored in the storage means 12, after which these names may be supplied by the address information provision device 10 in the form of receiver information DI to the information processing control means 8, and from the latter to the audio/video information processing means 6, so that the receiver names may be reproduced visually in the form of a list by the TV set 5. The input means 9 may also be used to select a name shown in this list of receiver names which, represented by a receiver selection information record DSI, may be communicated by the information processing control means 8 to the address information provision device 10. The address information provision device 10 may then, with the aid of the selection means 13, provide one of the address information records Aj1 to Aj5 corresponding to the selected receiver Rj, for transmission of the audio/video information AVI to the selected receiver Rj in accordance with the receiver selection information DSI.

The input means 9 are also designed so that the name of a potential receiver Rj may be input directly by a user. In this case, in which the option of selecting the name of one of the receivers Rj from the list which may be produced with the aid of the TV set 5 is not used, and a user of the HD recorder 1 enters a name or a portion of a name of one of the receivers Rj with the aid of the input means 9, the receiver selection information DSI represents the name or name element input by the user with the aid of the input means 9. In this case it may occur that no clear identification of one of the stored receivers Rj is possible with the aid of the selection means 13. To deal with this situation, the selection means 13 are designed to provide the name for selection according to the input of the user, or the corresponding address information Aji in the form of a list which in this case may also be supplied with the aid of the receiver information DI from the selection means 13 via the information processing control means 8 to the audio/video information processing means 6, and may be displayed to the user with the aid of the TV set 5, so that the user may select the name or receiver Rj actually intended by him. Only then is it possible, with the aid of the selection stage 15, to select the address information Aji corresponding to the manually selected receiver Rj.

The selection means 13 are also designed so that if, depending on the representation information RI, none of the address information records Aji corresponding to a selected receiver Rj can be selected, they are able to provide splitting information SI with the aid of which the transmission information TI to be transmitted, i.e. in this case the audio/video information AVI, may be split into transmission information elements. The selection means 13 are also designed to select and provide that address information Aji with the aid of which the complete audio/video information AVI may be transmitted to the receiver Rj consecutively or quasi-simultaneously in the form of transmission information elements. Such a situation exists for example if a user intends to transmit a video film to a receiver Rj or to his terminal device, and the terminal device—for whatever reason—is designed only to receive an e-mail, or is currently available only for that purpose. In this case the video film for example is split into transmission information elements with a volume of data which allows transmission by the e-mail transmission method, and each transmission information element is transmitted to the terminal device of the receiver Rj together with the splitting information SI in the form of an e-mail. With the aid of the splitting information SI, the receiver is then able to reassemble the transmission information elements to form the video film.

The transmission device 11 of the HD recorder 1 is designed to transmit the audio/video information AVI in accordance with the transmission method defined by the address information Aji, using the address information Aji provided by the address information provision device 10. For this purpose the transmission device 11 has a first transmission stage 16, a second transmission stage 17, a third transmission stage 18, a fourth transmission stage 19 and a fifth transmission stage 20, and network data processing means 21 cooperating with the five transmission stages 16 to 20. Each of the transmission stages 16 to 20 is designed to receive the transmission information TI from the information processing control means 8 and to feed the transmission information TI to the network data processing means 21 in accordance with the respectively assigned transmission method. The first transmission stage 16 is assigned the e-mail transmission method, the second transmission stage 17 is assigned the P2P transmission method, the third transmission stage 18 is assigned the FTP transmission method, the fourth transmission stage 19 is assigned the SMS transmission method and the fifth transmission stage 20 is assigned the IM transmission method. Consequently it is possible to process with the aid of the first transmission stage 16 the e-mail-related address information records A11, A21 or A31, and with the aid of the second transmission stage 17 the P2P-related address information records A12, A22 or A32, and with the aid of the third transmission stage 18 the FTP-related address information records A13, A23 or A33, and with the aid of the fourth transmission stage 19 the SMS-related address information records A14, A24 or A34, and with the aid of the fifth transmission stage 20 the IM-related address information records A15, A25 or A35. With the aid of the selection means 13, the respectively selected address information Aji may be fed to that transmission stage 16 to 20 which has a transmission method corresponding to the transmission method defined by the relevant address information Aji.

In accordance with the relevant transmission method, the audio/video information AVI together with the relevant address information Aji may be supplied to the network data processing means 21, which are designed to deliver the network data ND to the network 22. Depending on the address information Aji, the network data ND may be transmitted over the network 22 to one of the receiver units 23, 24, 25 or 26 shown in FIG. 1 and which may be clearly identified through the relevant address information Aji. It may be mentioned at this point that the address information Aji is also able to specify so-called virtual units or user accounts, which may be addressed in accordance with the transmission method concerned.

The first receiver unit 23 is assigned a first receiver R1 and has the transmission methods e-mail, P2P, FTP, SMS and IM at its disposal. Its realization corresponds substantially to that of the HD recorder 1. The second receiver unit 24 and the third receiver unit 25 are realized by virtual devices on a computer 26. The second receiver unit 24 has the transmission methods e-mail, SMS and IM at its disposal. The third receiver unit 25 has the transmission methods FTP and P2P at its disposal.

The second receiver unit 24 and the third receiver unit 25 form a receiver device which is provided to receive transmission information TI transmitted with the aid of the HD recorder 1 which realizes the transmission device, and specifically utilizing an e-mail message received beforehand, said e-mail message having request address information RAI. The request address information RAI states that the transmission information TI may be requested by a transmission information processing device, which does not have to be the HD recorder 1, using a transmission method which has been defined with the aid of the address information provision device 10 of the HD recorder 1 by selecting the address information A22 or A23 for transmission of the transmission information TI. In the present case, a so-called e-mail client of the second receiver unit 24 is so designed that the request address information RAI may be extracted from an e-mail message shown in FIG. 6 which has an XML instruction formulated in the so-called “Extended Markup Language”, XML in short, in which the request address information RAI is embedded. The extracted request address information RAI may be supplied to the second receiver unit 25 and there processed according to the transmission method defined by the address information A22 or A23 either with an FTP client 25A or a P2P client 25B. Accordingly the receiver unit 26 has a request stage, depending on the address information A22 or A23 defined in advance by the address information provision device 10 of the 1, realized either by the FTP client 25A or the P2P client 25B. This request stage is designed to request the transmission information RI from the transmission device addressed by the request address information RAI, in accordance with the transmission method P2P or FTP.

This is of advantage, for example, when the second receiver unit is concealed behind a firewall and can not be addressed from outside the firewall so that the receiver unit 25, on receiving the request address information RAI, must itself be active in order to initiate data transmission in accordance with the transmission method defined by the relevant address information A22 or A23. This measure may equally be of advantage when the HD recorder 1 is concealed behind a firewall or if the transmission information TI is provided on a buffer memory from which it may be transmitted to the receiver unit 26 with a time delay.

With the aid of a first typical application for the HD recorder 1 according to FIG. 1, the function of the HD recorder 1 and of the address information provision device 10 contained in the HD recorder 1 will now be discussed.

According to the typical application it is assumed that the owner and user of the HD recorder 1 is called Adolf Proidl. It is also assumed that, with the aid of the storage means 12, Adolf Proidl has compiled an electronic address book which contains, in the first record DS1, the address information A11 to A15 corresponding to his first friend Michael Schneider. In the second record DS2, the address book has the address information A21 to A25 corresponding to his second friend, named Hugh Cautley. The relevant address book entries A11 to A25 are shown in FIG. 2.

It is further assumed that Adolf Proidl, in the course of using the HD recorder 1, has recorded the video films “Shrek”, “Star-Wars I”, “Star-Wars II”, “Star-Wars III” and “Perfect-Patents” on the hard disk 2, so that these video films form the audio/video information AVI recorded on the hard disk 2. Corresponding to the audio/video information AVI, the contents list storage area 4 has all the necessary information suitable for characterizing the video films, in the form of content information CI.

In using the HD recorder 1, Adolf Proidl is shown with the aid of the TV set 5 a first image content 29, shown in FIG. 4, in the form of a menu of the HD recorder 1. The first image content 29 has a main menu name panel 30 and a first submenu name panel 31. In the main menu name panel 30 it is shown that Adolf Proidl, in using the HD recorder 1, is to be found on the hard disc video menu level. In the first submenu name panel 31 it is shown that the available information in this submenu relates to the video content stored with the aid of the hard disk. Following the first submenu name panel 31, a video film listing area 32 lists the names of the available video films, wherein the particular video film selected is marked by a relatively large circle to the left of the video film concerned. Shown in a video film description area 33 displayed alongside the video film listing area 32 are those details and information relating to the particular video film selected, which are of interest to the user. The first image content 29 also has a first execution menu area 34 in which are available those menu items of the menu which may be used to select and/or execute menu commands relating directly to the playback and/or editing and/or selection of one of the listed video films. The first image content 29 also has a management function menu area 35 in which are available those menu items which may be used to select and/or execute menu commands relating to administration of the video films stored on the hard disk 2. In the present case only the menu command SEND 36, which is relevant to the invention, will be discussed.

According to the typical application it is assumed that Adolf Proidl intends to send the video film “Shrek” to the first receiver R1, namely his friend Michael Schneider. Accordingly Adolf Proidl selects the video film “Shrek” in the video film listing area 32 and confirms his selection by actuating the menu command SELECT in the first execution menu area 34. Adolf Proidl then activates the menu command SEND 36, whereupon the first image content 29 reproduced with the aid of the TV set 5 is replaced by a second image content 37 shown in FIG. 4.

In contrast to the first image content 29, the second image content 37 has a second submenu name panel 38 in which it is shown that the selected film may be sent to a receiver who may be selected from a receiver listing area 39 arranged beneath the second submenu name panel 38. The second image content 37 also has a second execution menu area 40, through activation of which the sending of the video film “Shrek” is initiated. The second image content 37 also has a second management function menu area 41, which will not be discussed further since it is not relevant to the invention.

According to the typical application, Adolf Proidl now selects the name of his friend Michael Schneider in the receiver listing area 39 and activates the sending of the video film “Shrek” by pressing an OK button on his remote control, said OK button corresponding to the command “ok-send” listed in the second execution menu area 40.

Thereupon, firstly in the HD recorder 1, the content information CI corresponding to the video film “Shrek” is read out from the contents list storage area 4 with the aid of the information processing control means 8, and sent to the selection means 13, specifically to the analysis stage 14. An address information provision process is then started to provide the address information Aji for transmission of the video film “Shrek” to receiver R1, namely Michael Schneider, said receiver R1 being assigned five address information records A11 to A15 according to the first record DS1.

In accordance with the address information provision method, depending on the representation information RI representing the video film “Shrek”, address information A1i is first of all selected and provided for the transmission device 11. For this purpose the content information CI of the video film “Shrek” is analysed to see if it has details of the volume of data. The details of volume of data found in the content information CI finally form the representation information RI. In accordance with this analysis the analysis result information AIR is generated, which states that transmission of the video film “Shrek” by an e-mail transmission method or an SMS transmission method or an IM transmission method is inexpedient, since the actual volume of data exceeds that which is customary and can be processed sensibly from the technical standpoint, for these methods of transmission. On the basis of the analysis result information AIR the address information A13, according to which the FTP transmission method is used, is then selected by the selection stage 15 as the most suitable address information for transmission of the video film. This is also in particular because the representation information RI contains no indication as to whether or not the video film for Michael Schneider is to be made available in real time. The selection stage 15 accordingly interprets the absence of any priority criteria to the effect that the video film as a whole will be transmitted most economically with the aid of the FTP transmission method. On completion of transmission of the video film to the terminal device 23 of the friend Michael Schneider, the latter may then play this video film locally on his HD recorder forming the terminal device 23.

The function of the HD recorder 1 will now be discussed below with the aid of a second typical application for the HD recorder 1 according to FIG. 1.

According to this typical application it is assumed that the user Adolf Proidl is just playing a video film, for example the video film “Shrek”, from the hard disk 2 and showing it on the TV set 5. Adolf Proidl intends to allow his friend Michael Schneider, who is currently working on his terminal device 23, to participate in this playback, and manifests this desire by activating a menu command “SHARE” shown in FIG. 3, with the aid of which transmission to the receiver Michael Schneider may be characterized by real time priority information.

In the present case, the representation information RI forms a combination of the entry in the content information CI relating to the video film “Shrek” giving the volume of data of the latter, and the priority information which is communicated from the analysis stage 14 to the selection stage 15 with the aid of the analysis result information AIR. On the basis of this analysis result information AIR, the selection stage 15 selects in the present case the address information A12, according to which the P2P transmission method is used, since for the transmission of the video film in real time, the address information A13 would give an unsuitable transmission method. The address information A12 is passed to the second transmission stage 17, with the aid of which the video film is sent in real time over network 22 in accordance with the P2P transmission method, to the HD recorder of the receiver Michael Schneider, so that the latter may view the video film played back locally by Adolf Proidl at substantially the same time. In this connection the person skilled in the art will of course understand that the transmission of a copyright-protected video film may take place only under suitable framework conditions, under which no infingement of copyright occurs. In this context, however, this aspect will not be considered further. It should be noted only that this typical application applies in particular to private video recordings.

The functions of the HD recorder 1 will now be discussed below with the aid of a third typical application for the HD recorder 1 according to FIG. 1.

According to this typical application it is assumed that Adolf Proidl, the user of the HD recorder 1, has stored on the hard disk 2 still images, i.e. non-audio video information VI, in the present case representing holiday photos. He intends to transmit these digitally stored holiday photos, in the form of transmission information TI, to a supplier of a photo processing service.

In the present case it is also assumed that, as shown in FIG. 3, three different suppliers of such a photo processing service are stored in the three records DS1 to DS3. Adolf Proidl firstly selects the photos, displayed visually on the screen of the TV set 5, which he wishes to have printed on photographic paper. He then actuates the input means 9 and selects a menu command, not shown in FIGS. 3 and 4, with the description “photo processing”.

The information processing control means 8 pass the content information CI relating to the individual photos to the address information provision device 10 where it is determined, with the aid of the analysis stage 14, that the volume of data of the photos is transmitted preferably by the FTP transmission method. At the same time, with the aid of the information processing control means 8, the receiver information DI is sent to the selection means 13. In accordance with the address information provision method, the address information provision device 10 determines that address information assigned to several receivers R1, R2 and R3, namely A13, A23 and A33, may be selected, and the names of the receivers R1, R2 and R3 and the address information records A13, A23 and A33 are provided in the form of a list. With the aid of the information processing control means 8, the list is displayed visually to the user on the TV set 5. Adolf Proidl then selects the second receiver R2 from this list, and this is communicated to the address information provision device 10 with the aid of the receiver selection information DSI. Then, with the aid of the selection stage 15, the address information A23 is selected and sent to the third transmission stage 18. With the aid of the third transmission stage 18, the digital representation of the photos selected for processing is transmitted as transmission information TI to the receiver addressed in accordance with address information A23, by the FTP transmission method defined by address information A23.

The function of the HD recorder 1 will now be discussed below with the aid of a fourth typical application for the HD recorder 1 according to FIG. 1.

According to this fourth typical application it is assumed that Adolf Proidl wishes to send a single photo to his friend Michael Schneider for subsequent viewing. In the present case, the entries shown in FIG. 2 are stored in the records DS1 and DS2. The sending process is activated by actuating a menu command provided for this purpose, as already discussed in the previous typical applications. The address information provision device 10 then determines that the volume of data is sufficiently low for transmission by the e-mail transmission method to be possible. Therefore, with the aid of the selection stage 15, the address information A11 of Michael Schneider is passed to the first transmission stage 16, with the aid of which the single photo to be transmitted is sent to the receiver Michael Schneider in a relatively cost-efficient manner which is advantageous from the technical transmission standpoint.

The function of the HD recorder 1 will now be discussed below with the aid of a fifth typical application for the HD recorder 1 according to FIG. 1.

According to this fifth typical application it is assumed that the two records DS1 and DS2 contain the entries shown in FIG. 2. It is also assumed that Adolf Proidl wishes to send a fairly large number of photos to his friend Hugh Cautley. For this purpose Adolf Proidl first of all selects the photos to be sent via the menu or the user-interface of the HD recorder 1 and defines Adolf Proidl as the receiver. With the aid of the information processing control means 8, the receiver selection information DSI specifying Hugh Cautley as receiver, and the content information CI of the individual photos, are then sent to the analysis stage 14, which analyses the content information CI supplied to it and determines through the analysis result information AIR that the full volume of data to be transmitted would be sent most efficiently with the aid of an FTP transmission method. Since however there is no FTP address A23 available for Hugh Cautley, and the available address A25 for Hugh Cautley is not suitable for the transmission of this volume of data by the IM transmission method, selection stage 15 is used to select the sole address information A21, which defines the e-mail transmission method, and is suitable at least as a second choice for transmission of the present volume of data.

Also, in accordance with the address information provision method and with the aid of the selection stage 15 in cases where—as in the present case depending on the representation information RI, i.e. on the total volume of data to be transmitted—there is no address information A21 for selection, by which the entire volume of data might be preferably transmitted, the splitting information SI is provided. With the aid of the splitting information SI, which is sent together with the address information A21 via the selection stage 15 to the first transmission stage 16, the transmission information TI to be transmitted, i.e. the total number of digitally stored photos, may be split into transmission information elements, which in the present case are formed by the individual digital photos. In accordance with the address information provision method, as already described above, the address information A21 is selected and provided, with the aid of which the entire transmission information TI may be transmitted to the receiver Hugh Cautley in the form of transmission information elements. Accordingly each of the individual photos is attached to an e-mail and sent to the terminal device 25 or e-mail account of Hugh Cautley. There these individual photos may be assembled into a photo album, possibly using the splitting information SI which is also transmitted with the photos.

The function of the HID recorder 1 will now be discussed below with the aid of a sixth typical application for the data carrier 7 according to FIG. 1.

According to this typical application it is assumed that the two records DS1 and DS2 contain the entries shown in FIG. 2. It is also assumed that Adolf Proidl wishes to transmit the video film “Shrek” to his friend Hugh Cautley. Since however in the present case, due to a lack of address entries for Hugh Cautley, no transmission method is available which would allow the transmission of a volume of data of this size, no direct transmission from the HD recorder 1 to the second terminal device 24 is possible here. Since however—and in particular for future applications of the invention—it may be assumed that the terminal device 24 of Hugh Cautley very probably has FTP or P2P capability, or that Hugh Cautley has a further device—as in the present case the third terminal device 25—which is FTP—or P2P-capable, even though there are no entries to this effect in the address book of Adolf Proidl, the video film “Shrek” is for the time being provided on the hard disk 2 of the HD recorder 1 for subsequent collection by the terminal device of Hugh Cautley. For this purpose the video film is stored in transmission information storage means, which are formed by the hard disk 2. The transmission information storage means are provided for intermediate storage of the transmission information TI for the purpose of subsequent transmission in accordance with the FTP transmission method defined by the address information selected in advance as the preferred method, but not currently available. This means that the analysis stage 14 has indeed decided that the address information which appears to be the most suitable should define a FTP transmission method. Since however this is not available, a temporarily available internal FTP server is created with the aid of the HD recorder 1, to make the video film accessible to Hugh Cautley. For this purpose the video film “Shrek” is provided with password protection at the FTP address “ftp://hugh:passwd@130.146.110.105/pub/shrek/mpg” for subsequent collection.

Hugh Cautley is now sent an e-mail message, and specifically with the aid of address information A21, said e-mail message containing the instruction shown in FIG. 6 in the Extended-Markup-Language (XML), for collection of the stored video film. The XML instruction causes the terminal device 25 of Hugh Cautley to request the audio/video information AVI from the HD recorder 1 actively using the transmission method defined beforehand as preferred with the aid of the address information provision device 10. After the audio/video information AVI representing the video film “Shrek” has been transmitted from the HD recorder 1 to the terminal device 25 in accordance with the FTP transmission method, the video film may be played back on the terminal device 25. The audio/video information AVI stored temporarily on the HD recorder 1 is subsequently deleted together with the internal FTP server.

In this connection it should be mentioned that the video file now available to Hugh Cautley on terminal device 25 may also be made accessible by providing that, in the e-mail he has received, the link to the FTP server of the HD recorder 1 is automatically replaced by a link to the now locally stored video film.

In the case described above, the FTP transmission method was defined, with the aid of the address information provision device 10, as the preferred transmission method because no priority criterion was set by Adolf Proidl. However, in the situation where such a priority criterion is given, because Adolf Proidl wishes for example to make the audio/video information AVI momentarily available to Hugh Cautley, i.e. in real time, the address information provision device 10 is used to create, in similar fashion to the internal FTP server referred to above, an internal P2P server for transmission of the video film on request by Hugh Cautley's terminal device 25, with the aid of which the video film “Shrek” is made available to Hugh Cautley as it were in real time. In this case Hugh Cautley would receive an e-mail message differing from that shown in FIG. 6 in that, under “type” and “URI”, the entry FTP would be replaced by the entry P2P. Accordingly the terminal device 25 of Hugh Cautley could, immediately after receipt of the e-mail message on terminal device 24 and extraction and passing-on of the request address information RAI, request the video film from the HD recorder 1 by the P2P transmission method, whereupon the video film is transmitted to the terminal device 25 of Hugh Cautley in accordance with the P2P transmission method.

The function of the HD recorder 1 will now be discussed below with the aid of a seventh typical application for the HD recorder 1.

According to this typical application it is assumed that the HD recorder 1 of Adolf Proidl is behind a firewall and is therefore protected against external access, so that access to an internal FTP server or an internal P2P server, as described in the two preceding scenarios, is impossible in practice. For this situation it is provided that the HID recorder 1 sends the video film, which can not be transmitted directly to the terminal device 25 of Hugh Cautley owing to the lack of address information, for intermediate storage to an auxiliary server, not shown, for example with the designation “my.philips.com”. An e-mail message is then generated and sent to terminal device 24 of Hugh Cautley specifying as server from which the transmission information TI may be collected not the internal FTP server or the internal P2P server, but instead the auxiliary server “my.philips.com”. From this server—as in the typical applications cited above—the transmission information TI in buffer storage there may be collected in accordance with the preferred transmission method.

In a an analogous manner to this typical application, provision may also be made, if Adolf Proidl wishes to transmit a video film in real time to Michael Schneider, i.e. using the P2P transmission method, for the first record DS1 also to contain an actual P2P address A12. However in such a case an attempted transmission from the HD recorder 1 to the terminal device 23 of Michael Schneider may fail, if Michael Schneider has activated a firewall to protect his terminal device 23. In this case too, an e-mail would be sent from the HD recorder 1 to the terminal device 23 with the aid of the address information provision device 10. This e-mail would contain an XML instruction C analogous to the XML instruction C shown in FIG. 6, so that the terminal device 23 of Michael Schneider can retrieve the audio/video information AVI stored on the HD recorder 1 by the transmission method basically preferred for the transmission of this volume of data, from a P2P address to be found on the auxiliary server “my.philips.com”. The retrieved transmission information TI is then transmitted from the auxiliary server to the terminal device 23 of Michael Schneider by the P2P transmission method defined by the previously selected address information A12.

Shown in FIG. 7 is an HD recorder 1′ which, in contrast to the HD recorder 1 shown in FIG. 1, has no address information provision device 10. Also shown in FIG. 7 is an address server 27 which has the address information provision device 10 provided and designed to execute the address information provision method according to the invention.

The address server 27 is realized by a computer with a central processing unit and an internal memory, wherein the computer runs a computer program product which is stored on a computer-readable medium such as for example a hard disk of the computer or a DVD or a CD and may be loaded directly into the memory of the computer and comprises software code sections. At the same time the computer is used to execute the address information provision method according to the invention, when the computer program product is run on the computer.

In the present case the HD recorder 1′ is designed to supply a representation of a receiver Rj and the content information CI corresponding to the transmission information TI to the address information provision device 10 localized in the address server. There, depending on the representation information RI supplied, i.e. depending on the content information CI which may be evaluated for this purpose, the address information provision device 10 selects the relevant address information Aji, which in the present case is communicated back to the HD recorder 1′. At this point it should be mentioned that the address server 27 may be designed, in the absence of content information CI which may be evaluated in respect of representation information RI, to receive a portion or the whole of the transmission information TI and independently to analyze and evaluate this information in order to generate representation information RI of this transmission information TI and to select the address information Aji corresponding to the receiver Rj concerned, depending on the representation information RI which it has itself generated. The HD recorder 1′ is designed, on receipt of the relevant address information Aji, which is fed to the transmission device 11 of the HD recorder 1′, to transmit the relevant transmission information TI to the relevant receiver Rj in accordance with the transmission method defined by the address information Aji.

In the present case the address information provision device 10 is designed, if a receiver Rj is not clearly specified and address information Aji assignable to several receivers Rj may be selected, to provide the receivers Rj available for selection and the relevant address information Aji in the form of a list, wherein the address information records Aji are arranged in order of a fee, which is to be paid in advance by the addressees to the operator of the address information server 22. This makes possible a business model in which for example the suppliers of a photo processing service appear at different positions in the list of address information records Aji, depending on the fee paid by them to the operator of the address server 27. This makes possible the targeted supply of a service, since a user of the HD recorder 1 will generally select the address information Aji appearing first in a list of receivers Rj which seem to be of equal value for this purpose. However it may be mentioned here that the order in the list may also depend on the turnover achieved directly or indirectly by the suppliers of the photo processing service with the aid of the address server 27.

It should also be mentioned that the address information provision device 10 may also be designed for actively checking for the existence of transmission information TI addressed to a receiver Rj. This is of particular benefit when the transmission is to be made automatically outside main office hours, since at this time the network 22 is usually not congested.

It may also be mentioned that the transmission information elements into which the complete transmission information to be transmitted may be split, may have for example as first transmission information element a video film and as second transmission information element text information which the sender of the video film wishes to send to the receiver of the video film as explanatory information. The transmission of the complete transmission information in the form of the two transmission information elements is then advantageous if the terminal device of the receiver is unable to process the complete transmission information, i.e. the combination of video film and text information, as such, but is however designed to receive each transmission information element in itself and to combine the two transmission information elements logically with the aid of the splitting information. A similar situation arises when the sender wishes to make the video film available to the receiver in real time, while at the same time informing the receiver of this fact through so-called chart information.

In connection with the transmission of a video film in real time it should also be mentioned that for this purpose a so-called “real time streaming protocol”, RTSP in short, may be used, to allow the joint viewing of a film on the basis of the P2P transmission method.

1. Address information provision device (10), said address information provision device (10) being provided for the provision of address information (Aji) for transmission of transmission information (TI) to a receiver (Rj), to whom at least two address information records (Aji) are assigned, and said address information provision device (10) having storage means (12), which are provided for the storage of the two or more address information records (Aji) assigned to the receiver, wherein each address information record (Aji) defines a transmission method (TI) for transmission of the transmission information, and said address information provision device (10) having selection means (13) to which representation information (RI) representing the transmission information (TI) to be transmitted may be supplied and which are designed, depending on the representation information (RI) supplied, to select and provide at least one address information record (Aji).

2. Address information provision device (10) according to claim 1, wherein the selection means (13) have an analysis stage (14) which is designed to analyze the representation information (RI) and to provide analysis result information (AIR) characterizing the representation information (RI), and wherein the selection means (13) are designed, with the aid of the analysis result information (AIR), to select the address information (Aji).

3. Address information provision device (10) according to claim 1 wherein the selection means (13) if, depending on the representation information (RI), address information (Aji) assigned to several receivers (Rj) may be selected, are designed to provide the address information (Aji) available for selection in the form of a list, wherein each address information record (Aji) is ranked in the list according to one or more ranking criteria.

4. Address information provision device (10) according to claim 3, wherein each address information record (Aji) is ranked according to a fee.

5. Address information provision device (10) according to claim 1 wherein if, depending on the representation information (RI), no address information (Aji) can be selected, the selection means (13) are designed to provide splitting information (SI) with the aid of which the transmission information (TI) to be transmitted may be split into transmission information elements, and are designed to select and provide the address information (Aji) with the aid of which the complete transmission information (TI) may be transmitted to the receiver (Rj) in the form of transmission information elements, (Rj).

6. Address information provision method for the provision of address information (Aji) for transmission of transmission information (TI) to a receiver (Rj) to whom at least two address information records (Aji) are assigned, wherein at least two address information records (Aji) assigned to the receiver (Rj), each defining a transmission method for the transmission of the transmission information (TI), are stored, and wherein, depending on representation information (RI) which represents the transmission information (TI), at least one address information record (Aji) is selected and provided.

7. Address information provision method according to claim 6, wherein the representation information (RI) is analyzed and analysis result information (AIR) characterizing the representation information (RI) is generated and wherein the address information (Aji) is selected with the aid of the analysis result information (AIR).

8. Address information provision method according to claim 6 wherein if, depending on the representation information (RI), address information (Aji) assigned to several receivers (Rj) may be selected, the address information (Aji) available for selection is provided in the form of a list, wherein each address information record (Aji) is ranked in the list according to a ranking criterium.

9. Address information provision method according to claim 8, wherein each address information record (Aji) is ranked according to a fee.

10. Address information provision method according to claim 6 wherein if, depending on the representation information (RI), no address information (Aji) can be selected, splitting information (SI) is provided with the aid of which the transmission information (TI) to be transmitted may be split into transmission information elements, and address information (Aji) is selected and provided, with the aid of which the complete transmission information (TI) may be transmitted to the receiver (Rj) in the form of transmission information elements.

11. Transmission information processing device (1), said transmission information processing device (1) being provided to process transmission information (TI), and said transmission information processing device (1) having an address information provision device (10) as claimed in claim 1, and said transmission information processing device (1) having a transmission device (11) which is designed, using the address information (Aji) provided by the address information provision device (10), to transmit the transmission information (TI) in accordance with the transmission method defined by the address information (Aji).

12. Transmission information processing device (1) according to claim 11, wherein transmission information storage means (2) are provided for buffer storage of the transmission information (TI) and a representation of the address information (Aji) for the purpose of subsequent transmission in accordance with the transmission method, said transmission method being defined by the address information (Aji), said address information (Aji) having been provided by the address information provision device (10).

13. Computer program product, said computer program product being capable of direct loading into a computer memory and comprising software code sections, wherein the computer may be used to execute the address information provision method as claimed in claim 6, when the computer program product is run on the computer.

14. Computer program product according to claim 13, wherein the computer program product is stored on a computer-readable medium.

15. Computer with a central processor unit and an internal memory, said computer running the computer program product as claimed in claim 13.

16. Receiver device (26), said receiver device (26) being designed to receive transmission information (TI) which may be transmitted with the aid of a transmission device utilizing a message received beforehand, said message having request address information (RAI), wherein the request address information (RAI) specifies the transmission device from which the transmission information (TI) may be requested using said transmission method, said transmission method having been defined with the aid of the address information provision device (10) as claimed in claim 1, by selection of the address information (Aji) for transmission of the transmission information (TI), and said receiver device (26) having a request stage (25A, 25B), said request stage being designed to request the transmission information (TI) from the transmission device addressed by the request address information (RAI), in accordance with the transmission method.

17. Receiver device (26) according to claim 16, wherein the receiver device (26) is designed to process a message which is formed by an e-mail message.

18. Receiver device (26) according to claim 16, wherein the receiver device (26) is designed to process a message, said message specifying the request address information (RAI) with the aid of so-called “Extended-Markup-Language”.
